(19) United States
(12) Patent Application Publication
(10) Pub. No.: US 2023/0086447 A1
(43) Pub. Date: Mar. 23, 2023

(54) CAT HOUSE CAPABLE OF BEING SPLICED

(71) Applicant: THEHILL SYSTEMS CO., LTD, Taoyuan City (TW)

(72) Inventors: YING-HUNG LAN, Taichung City (TW); KUAN-HUNG CHEN, Taoyuan City (TW)

(21) Appl. No.: 17/477,552

(22) Filed: Sep. 17, 2021

(51) Int. Cl. A01K 1/03; A01K 15/02

(52) U.S. Cl. CPC A01K 1/033; A01K 15/024

(57) ABSTRACT

A cat house capable of being spliced includes: a side wall defining an accommodating space, and including a connecting hole communicating with the accommodating space, plural fixing holes surrounding the accommodating space, and plural inner corners facing the accommodating space, at least one of the inner corners is 120 degrees; a reinforcing plate disposed in the accommodating space and including plural positioning ribs inserted through the fixing holes, and one of the positioning ribs including a reinforcing hole; and a reinforcing pin inserted in the reinforcing hole in such a manner that the body section is located in the reinforcing hole, and the head section and the tail section are abutted against an outer surface of the side wall. Since the side walls of both a pentagonal cat house and a hexagonal cat house have 120-degree inner corners, the cat houses can be spliced to each other.

### BACKGROUND

### Field of the Invention

The present invention relates to cat supplies, and more particularly to a cat house capable of being spliced.

### Related Prior Art

Nowadays, there are more and more people keeping pets, but the urban living space is so small that the range of activities of pets kept in homes is reduced. Therefore, some businesses have launched cat houses for pets to increase the activity space for pets.

However, the conventional cat house is large and heavy, and the structure is also very complicated, which is not easy for the owner to disassemble and store, and it is difficult to change the appearance of the cat house according to the needs. In addition, even the industry has developed detachable cat houses, but their structures are fragile and easy to collapse and deform, causing safety concerns.

In view of this, the development of a cat house with a stable structure has become the goal of the relevant industry.

### SUMMARY

One objective of the present invention is to provide a cat house whose appearance can be changed arbitrarily according to the needs of the owner, and the structure of the cat house is ensured to be strong.

To achieve the above objective, a cat house capable of being spliced provided by the invention comprises:

a side wall surrounding and defining an accommodating space, and including a connecting hole communicating with the accommodating space, the side wall further including a plurality of fixing holes surrounding the accommodating space, and a plurality of inner corners facing the accommodating space, wherein at least one of the inner corners has an angle of 120 degrees;

a reinforcing plate disposed in the accommodating space and including a plurality of positioning ribs, each of the positioning ribs being inserted through a corresponding one of the fixing holes, and one of the positioning ribs including a reinforcing hole; and

a reinforcing pin including a head section, a body section, and a tail section that are sequentially connected, the reinforcing pin being inserted in the reinforcing hole in such a manner that the body section is located in the reinforcing hole, and the head section and the tail section are abutted against an outer surface of the side wall.

In a preferred embodiment, the side wall includes an upper section side wall and a lower section side wall and are made of rectangular cardboard, the upper section side wall and the lower section side wall jointly surround and define the accommodating space, the upper section side wall include two upper clamping ribs, the lower section side wall includes two lower clamping ribs, the upper section side wall surrounds the reinforcing plate and is clamped on the reinforcing plate by the two upper clamping ribs, and the lower section side wall surrounds the reinforcing plate and is clamped on the reinforcing plate by the two lower clamping ribs.

In a preferred embodiment, the upper clamping ribs and the lower clamping ribs are pressed against each other.

In a preferred embodiment, a cat scratching board is disposed in the accommodating space.

In a preferred embodiment, the outer surface of the side wall is pasted with hook and loop tapes.

In a preferred embodiment, the hook and loop tapes are provided on the outer surface of the side walls that defines the inner corners.

In a preferred embodiment, the reinforcing plate is made of cardboard.

In a preferred embodiment, the side wall is made of rectangular cardboard, the rectangular cardboard is bent and surrounds to define the accommodating space, and the connecting hole is arranged on a long side of the cardboard.

Since both the pentagonal side wall and the hexagonal side wall have 120-degree inner corners, when the user stacks the hexagonal side wall on the pentagonal side wall at the positions corresponding to the 120-degree inner angles, a 120-degree outer corner will be formed between the pentagonal side wall and the hexagonal side wall. As shown in FIG. 4, another hexagonal side wall with an inner angle of 120 degrees is stacked, since the invention has at least one 120-degree inner corner, the cat houses can be spliced to each other. Furthermore, because the side wall of this invention is formed by bending a cardboard, in order to make the structure stronger, the reinforcing pin is inserted in the reinforcing hole in such a manner that the body section is located in the reinforcing hole, and the head section and the tail section are abutted against an outer surface of the side wall, thereby allowing the reinforcing pin to clamp the positioning rib, preventing the positioning rib from disengaging from the fixing hole, so as to strengthen the overall structure and make it more stable.

### BRIEF DESCRIPTION OF THE DRAWINGS

FIG. 1 is a perspective view of the invention in a preferred embodiment;

FIG. 2 is a three-dimensional exploded view of the invention in a preferred embodiment;

FIG. 3 is a magnified view of a part of FIG. 2;

FIG. 4 is an illustrative view of multiple cat houses stacked; and

FIG. 5 is a cross-sectional view taken along the line 5-5 in FIG. 4.

### DETAILED DESCRIPTION

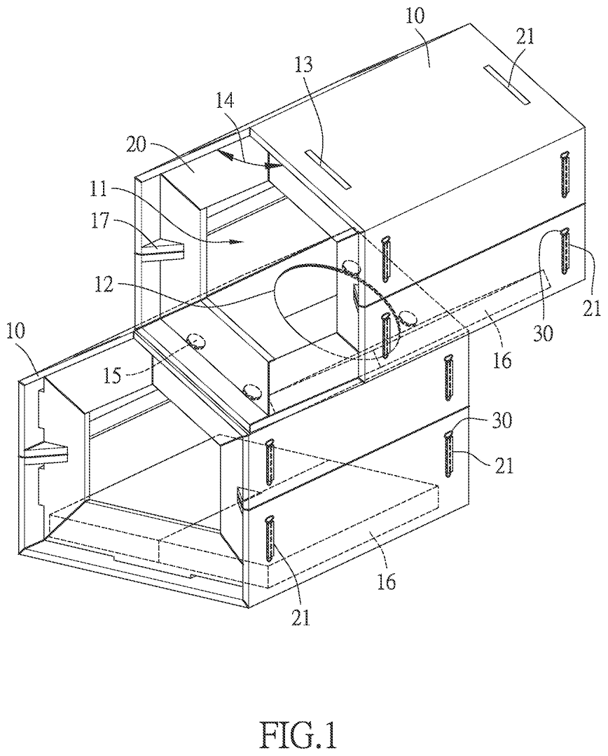

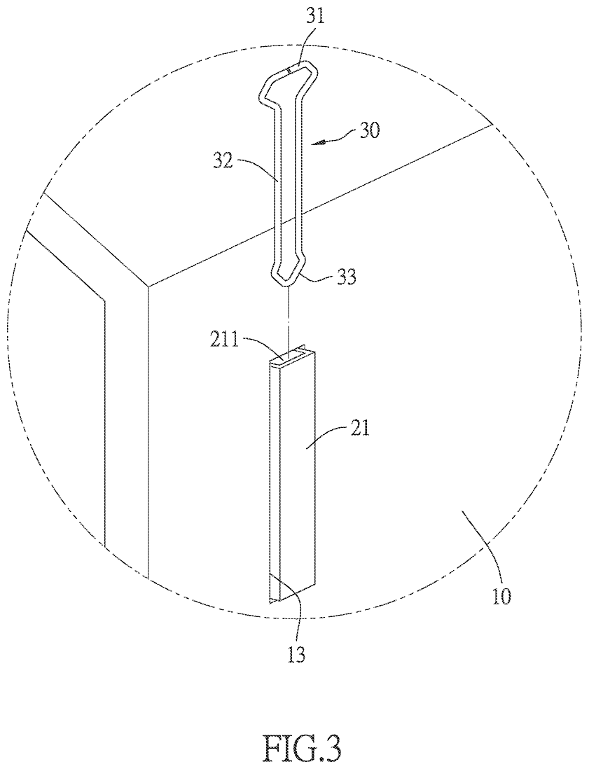

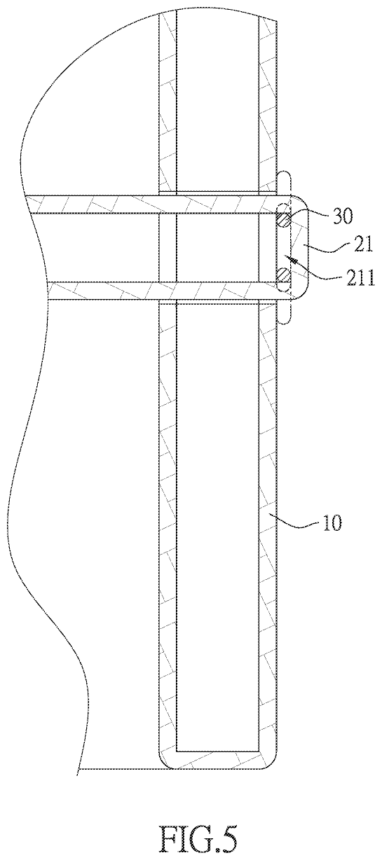

Please refer to FIGS. 1-5, the present invention provides a cat house capable of being spliced, which essentially comprises a side wall 10, a reinforcing plate 20 and a reinforcing pin 30, among which:

The side wall 10 surrounds and defines an accommodating space 11, and includes a connecting hole 12 communicating with the accommodating space 11. The side wall 10 further includes a plurality of fixing holes 13 surrounding the accommodating space 11, and a plurality of inner corners 14 facing the accommodating space 11. At least one of the inner corners 14 has an angle of 120 degrees. In this embodiment, the side wall 10 can be made of rectangular cardboard, and the rectangular cardboard is bent and surrounds to define the accommodating space 11, and the connecting hole 12 is arranged on the long side of the cardboard, so that when the rectangular cardboard is bent into shape, the communicating holes 12 surround the accommodating space 11.

The reinforcing plate 20 is arranged in the accommodating space 11 and includes a plurality of positioning ribs 21, each of the positioning ribs 21 is inserted through a corresponding one of the fixing holes 13, and one of the positioning ribs 21 includes a reinforcing hole 211; In this embodiment, the reinforcing plate 20 is made of cardboard.

The reinforcing pin 30 includes a head section 31, a body section 32, and a tail section 33 that are sequentially connected. The reinforcing pin 30 is inserted in the reinforcing hole 211 in such a manner that the body section 32 is located in the reinforcing hole 211, and the head section 31 and the tail section 33 are abutted against an outer surface of the side wall 10.

In this embodiment, the outer surface of the side wall 10 is pasted with hook and loop tapes 15 so that when there are a plurality of cat houses capable of being spliced, the cat house stacked on the topmost can be fixed through the hook and loop tapes 15. More preferably, the aforementioned hook and loop tapes l5 are provided on the outer surface of the side wall 10 that defines the inner corners 14, so that a plurality of cat houses capable of being spliced can be bonded and fixed to each other.

Furthermore, a cat scratching board 16 is disposed in the accommodating space 11, and the cat scratching board 16 can be used for grinding claws. Finally, the side wall 10 includes an upper section side wall 10A and a lower section side wall 10B. The upper section side wall 10A and the lower section side wall 10B are made of rectangular cardboard, and jointly surround and define the accommodating space 11. The upper section side wall 10A and the lower section side wall 10B respectively include two clamping ribs 17, the two clamping ribs 17 of the upper section side wall 10A are two upper clamping ribs 17A, and the two clamping ribs 17 of the lower section side wall 10B are two lower clamping ribs 17B. The upper section side wall 10A surrounds the reinforcing plate 20, and is clamped on the reinforcing plate 20 by the two upper clamping ribs 17A. The lower section side wall 10B surrounds the reinforcing plate 20 and is clamped on the reinforcing plate 20 by the two lower clamping ribs 17B, thereby enhancing the stability of the side wall 10.

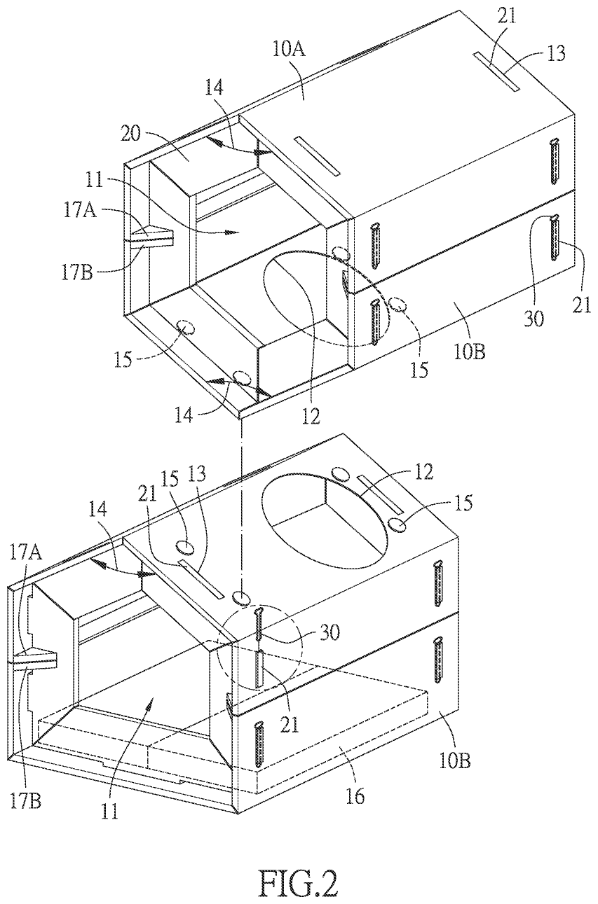

In particular, please refer to FIGS. 1 and 2. The upper section side wall 10A and the lower section side wall 10B are made of rectangular cardboard, and the upper clamping ribs 17A and the lower clamping ribs 17B are formed by bending two ends of the rectangular cardboard. The upper clamping ribs 17A and the lower clamping rib 17B are pressed against each other, thereby making the upper section side wall 10A and the lower section side wall 10B more stable.

The above is the structural configuration and connection relationship of the present invention in a preferred embodiment. The use of the present invention and the effects it can produce are as follows:

Please refer to FIG. 1, the user can fold the upper section side wall 10A and the lower section side wall 10B into different shapes, and then combine them into side walls 10 of different shapes; taking the one disclosed in FIG. 1 as an example, if the lower section side wall 10B is folded into a shape with two adjacent 90-degree inner corners 14, the upper section side wall 10A is folded into a shape with three 120-degree inner corners 14, and finally the upper section side wall 10A and the lower section side wall 10B are combined with each other to form the side wall 10 in the shape of a pentagon. If both the lower section side wall 10B and the upper section side wall 10A are folded into a shape with three 120-degree inner corners 14, they can be combined with each other to form a hexagonal side wall 10.

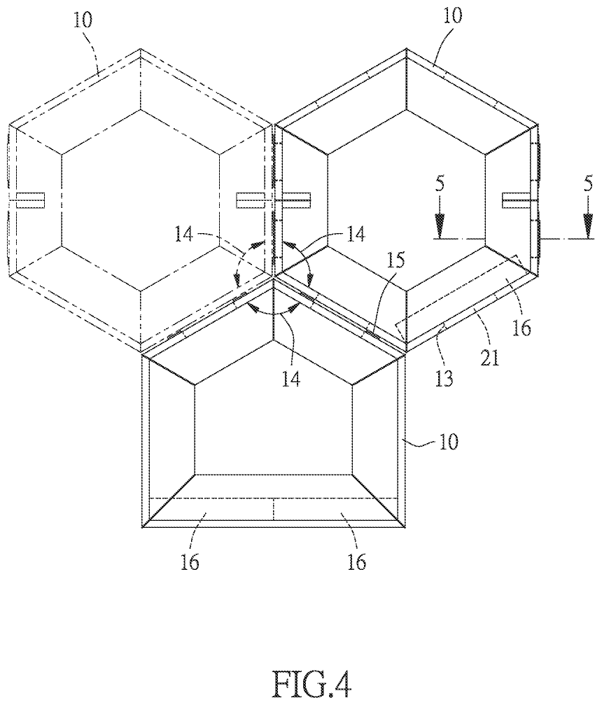

Since both the pentagonal side wall 10 and the hexagonal side wall 10 have 120-degree inner corners 14, when the user stacks the hexagonal side wall 10 on the pentagonal side wall 10 at the positions corresponding to the 120-degree inner angles 14, a 120-degree outer corner will be formed between the pentagonal side wall 10 and the hexagonal side wall 10. As shown in FIG. 4, another hexagonal side wall 10 with an inner angle 14 of 120 degrees is stacked, since the invention has at least one 120-degree inner corner, the cat houses can be spliced to each other.

It is worth mentioning that because the side wall 10 of this invention is formed by bending a cardboard, in order to make the structure stronger, the reinforcing pin 30 is inserted in the reinforcing hole 211 in such a manner that the body section 32 is located in the reinforcing hole 211, and the head section 31 and the tail section 33 are abutted against an outer surface of the side wall 10, thereby allowing the reinforcing pin 30 to clamp the positioning rib 21, preventing the positioning rib 21 from disengaging from the fixing hole 13, so as to strengthen the overall structure and make it more stable.

What is claimed is:

1. A cat house capable of being spliced, comprising:
a side wall surrounding and defining an accommodating space, and including a connecting hole communicating with the accommodating space, the side wall further including a plurality of fixing holes surrounding the accommodating space, and a plurality of inner corners facing the accommodating space, wherein at least one of the inner corners has an angle of 120 degrees;
a reinforcing plate disposed in the accommodating space and including a plurality of positioning ribs, each of the positioning ribs being inserted through a corresponding one of the fixing holes, and one of the positioning ribs including a reinforcing hole; and
a reinforcing pin including a head section, a body section, and a tail section that are sequentially connected, the reinforcing pin being inserted in the reinforcing hole in such a manner that the body section is located in the reinforcing hole, and the head section and the tail section are abutted against an outer surface of the side wall.

2. The cat house capable of being spliced as claimed in claim 1, wherein the side wall includes an upper section side wall and a lower section side wall and are made of rectangular cardboard, the upper section side wall and the lower section side wall jointly surround and define the accommodating space, the upper section side wall include two upper clamping ribs, the lower section side wall includes two lower clamping ribs, the upper section side wall surrounds the reinforcing plate and is clamped on the reinforcing plate by the two upper clamping ribs, and the lower section side wall surrounds the reinforcing plate and is clamped on the reinforcing plate by the two lower clamping ribs.

3. The cat house capable of being spliced as claimed in claim 2, wherein the upper clamping ribs and the lower clamping ribs are pressed against each other.

4. The cat house capable of being spliced as claimed in claim 1 further comprising a cat scratching board is disposed in the accommodating space.

5. The cat house capable of being spliced as claimed in claim 1, wherein the outer surface of the side wall is pasted with hook and loop tapes.

6. The cat house capable of being spliced as claimed in claim 5, wherein the hook and loop tapes are provided on the outer surface of the side wall that defines the inner corners.

7. The cat house capable of being spliced as claimed in claim 1, wherein the reinforcing plate is made of cardboard.

8. The cat house capable of being spliced as claimed in claim 1, wherein the side wall is made of rectangular cardboard, the rectangular cardboard is bent and surrounds to define the accommodating space, and the connecting hole is arranged on a long side of the cardboard.
